(19) United States
(12) Patent Application Publication
(10) Pub. No.: US 2018/0096762 A1
(43) Pub. Date: Apr. 5, 2018

(54) SINTERED R-TM-B MAGNET

(71) Applicant: HITACHI METALS, LTD., Tokyo (JP)

(72) Inventors: Daisuke YAMAMICHI, Kumagaya-shi (JP); Masanao KAMACHI, Kumagaya-shi (JP); Rintaro ISHII, Mishima-gun (JP); Takahiro KATOU, Kumagaya-shi (JP)

(73) Assignee: HITACHI METALS, LTD., Tokyo (JP)

(21) Appl. No.: 15/720,251

(22) Filed: Sep. 29, 2017

(30) Foreign Application Priority Data
Sep. 30, 2016 (JP) 2016-193497

(51) Int. Cl. H01F 1/053; C22C 38/00; C22C 38/16; C22C 38/06; C22C 38/08; C22C 38/12

(52) U.S. Cl. CPC H01F 1/0536; C22C 38/005; C22C 38/16; C22C 38/12; C22C 38/08; C22C 38/002; C22C 38/06

(57) ABSTRACT

A sintered R-TM-B magnet comprising 24.5-34.5% by mass of R, wherein R is at least one selected from rare earth elements including Y, 0.92-1.15% by mass of B, less than 0.1% by mass of Ni, 0.07-0.5% by mass of Ga, 0-0.4% by mass of Cu, and inevitable impurities, the balance being Fe; the amounts (% by mass) of Ga and Cu being in a region of a pentagon defined by a point A (0.5, 0.0), a point B (0.5, 0.4), a point C′ (0.1, 0.4), a point D′ (0.1, 0.1) and a point E (0.2, 0.0), on an X-Y plane in which the X-axis represents the amount of Ga, and the Y-axis represents the amount of Cu.

### FIELD OF THE INVENTION

The present invention relates to a sintered R-TM-B magnet having improved corrosion resistance, and an anisotropic, cylindrical, sintered R-TM-B magnet suffering less breakage.

### BACKGROUND OF THE INVENTION

Sintered R-TM-B magnets are widely used because of high magnetic properties, though they are vulnerable to corrosion because they contain rare earth elements (R elements) as main components. It is known that corrosion starts from rare-earth-rich phases, and proceeds with the main phases detached successively. Though corrosion-resistant coatings are usually formed (painted or plated) on the sintered R-TM-B magnets to prevent corrosion, they are water-vapor-permeable to some extent, failing to completely prevent the corrosion of the magnets.

Polar-anisotropic, cylindrical magnets and radially anisotropic, cylindrical magnets are known as typical forms of the sintered R-TM-B magnets. The use of these cylindrical magnets for rotors makes assembling easy, because they need not be attached to rotors one by one unlike arcuate magnets.

However, these cylindrical magnets are likely to have internal stress, which is generated by different linear thermal expansion coefficients between a direction parallel to the C-axis and a direction perpendicular to the C-axis due to anisotropy. When this stress exceeds the mechanical strength of cylindrical magnets, breakage and cracking occur as described, for example, in JP 64-27208 A. In the case of block-shaped magnets, though, stress would be released from them even with different linear thermal expansion coefficients, resulting in no stress remaining in the magnets.

JP 2-4939 A discloses the substitution of part of Fe with Co and Ni for improving the corrosion resistance of magnets. However, the substitution of part of Fe with Ni is practically difficult, because it drastically reduces magnetic properties. In addition to the deterioration of magnetic properties, the addition of Ni likely reduces the strength of magnets.

JP 2015-53517 A discloses the addition of Ni, Si and Cu for suppressing the deterioration of magnetic properties, which occurs by the addition of Ni despite improvement in corrosion resistance. However, the addition of Ni likely reduces the strength of the magnet.

JP 2013-216965 A discloses an alloy for a sintered R-T-B rare earth magnet, which comprises a rare earth element R, a transition metal T including Fe as an indispensable element, one or more metal elements M selected from Al, Ga and Cu, B, and inevitable impurities. However, it describes neither the improvement of corrosion resistance and strength, nor the use of the sintered R-T-B rare earth magnet alloy for cylindrical magnets.

Though the addition of Ni improves the corrosion resistance of sintered R-TM-B magnets as described above, it reduces their mechanical strength, particularly causes breakage, chipping and cracking when used as polar-anisotropic, cylindrical magnets and radially anisotropic, cylindrical magnets. Accordingly, their production needs sufficient attention, because a sufficient amount of Ni cannot be added to have enough corrosion resistance, and cylindrical magnets should have large sizes (radial sizes) to have enough mechanical strength.

### Objects of the Invention

Accordingly, an object of the present invention is to provide a sintered R-TM-B magnet having high mechanical strength and excellent corrosion resistance without containing Ni.

Another object of the present invention is to provide an anisotropic, cylindrical, sintered R-TM-B magnet suffering less breakage, chipping and cracking.

### SUMMARY OF THE INVENTION

As a result of intensive research in view of the above objects, the inventors have found that sintered R-TM-B magnets containing Ga or (Ga+Cu) exhibit excellent corrosion resistance without scarifying mechanical strength, even when they contain substantially no Ni, so that they suffer less breakage, chipping, cracking, etc. when formed into anisotropic cylindrical sintered magnets likely having large residual stress. The present invention has been completed based on such finding.

Thus, the sintered R-TM-B magnet of the present invention comprises 24.5-34.5% by mass of R, wherein R is at least one selected from rare earth elements including Y, 0.92-1.15% by mass of B, less than 0.1% by mass of Ni, 0.07-0.5% by mass of Ga, 0-0.4% by mass of Cu, and inevitable impurities, the balance being Fe;

the amounts (% by mass) of Ga and Cu being in a region of a pentagon defined by a point A (0.5, 0.0), a point B (0.5, 0.4), a point C′ (0.1, 0.4), a point D′ (0.1, 0.1) and a point E (0.2, 0.0), on an X-Y plane in which the X-axis represents the amount of Ga, and the Y-axis represents the amount of Cu.

The sintered R-TM-B magnet of the present invention may further contain 3% or less by mass of M, which is at least one selected from Zr, Nb, Hf, Ta, W, Mo, Al, Si, V, Cr, Ti, Ag, Mn, Ge, Sn, Bi, Pb and Zn.

The amount of B is preferably 0.92-1.10% by mass.

The amounts (% by mass) of Ga and Cu are preferably in a region of a tetragon defined by a point A′ (0.5, 0.1), a point B (0.5, 0.4), a point C″ (0.2, 0.4) and a point D″ (0.2, 0.1), on an X-Y plane in which the X-axis represents the amount of Ga, and the Y-axis represents the amount of Cu.

In the sintered R-TM-B magnet, the weight difference (weight loss by corrosion) before and after a pressure cooker test (120° C., 100% RH, 2 atoms, and 96 hours) is preferably less than 2 mg/cm².

The sintered R-TM-B magnet is preferably a radially anisotropic, cylindrical magnet or a polar-anisotropic, cylindrical magnet.

### BRIEF DESCRIPTION OF THE DRAWINGS

FIG. 1 is a graph showing the ranges of the amounts of Cu and Ga contained in the sintered R-TM-B magnet of the present invention.

FIG. 2 is a schematic view showing a molding apparatus for forming a radially anisotropic R-TM-B ring magnet used in Experiment 4.

FIG. 3(a) is a cross-sectional view schematically showing a molding apparatus for forming a polar-anisotropic R-TM-B ring magnet used in Experiment 5.

FIG. 3(b) is a cross-sectional view taken along the line A-A in FIG. 3(a).

FIG. 4 is a schematic view showing a method of measuring the strength of a sintered body.

FIG. 5 is a graph showing the relation between the amount of B and fracture toughness in the sintered R-TM-B magnet produced in Experiment 9.

### DESCRIPTION OF THE PREFERRED EMBODIMENTS

(1) Composition

The sintered R-TM-B magnet of the present invention comprises 24.5-34.5% by mass of R, wherein R is at least one selected from rare earth elements including Y, 0.92-1.15% by mass of B, less than 0.1% by mass of Ni, 0.07-0.5% by mass of Ga, 0-0.4% by mass of Cu, and inevitable impurities, the balance being Fe;

the amounts (% by mass) of Ga and Cu being in a region of a pentagon defined by a point A (0.5, 0.0), a point B (0.5, 0.4), a point C′ (0.1, 0.4), a point D′ (0.1, 0.1) and a point E (0.2, 0.0), on an X-Y plane in which the X-axis represents the amount of Ga, and the Y-axis represents the amount of Cu.

The sintered R-TM-B magnet of the present invention preferably substantially consists of R-TM-B. R is at least one selected from rare earth elements including Y, preferably containing at least one of Nd, Dy and Pr as an indispensable element. TM is at least one of transition metal elements, preferably substantially Fe in the present invention. B is boron.

It preferably does not contain Co. The addition of Co undesirably results in reduced mechanical strength. However, less than 0.1% by mass of Co introduced as an inevitable impurity of Fe may be contained. The amount of Co is more preferably less than 0.04% by mass.

The sintered R-TM-B magnet contains 24.5-34.5% by mass of R. When the amount of R is less than 24.5% by mass, the magnet has low residual magnetic flux density Br and coercivity iHc. When the amount of R is more than 34.5% by mass, rare-earth-rich phases are dominant in the sintered body, resulting in low residual magnetic flux density Br and corrosion resistance.

The sintered R-TM-B magnet may contain 0.85-1.15% by mass of B. The amount of B is preferably 0.89-1.15% by mass, more preferably 0.92-1.15% by mass, most preferably 0.92-1.1% by mass. When the amount of B is less than 0.85% by mass, B is insufficient to form main phases of R₂Fe₁₄B, so that soft-magnetic R₂Fe₁₇ phases are formed, resulting in low coercivity. On the other hand, when the amount of B is more than 1.15% by mass, non-magnetic B-rich phases increase, resulting in a low residual magnetic flux density. Also, a reduced amount of B leads to low toughness, resulting in easy chipping, which requires careful handling. Though 0.85% or more of B provides necessary toughness as long as careful handling is conducted, the amount of B is preferably 0.89% or more, more preferably 0.92% or more. 0.92% or more of B drastically reduces chipping. 0.89% or more of B provides the toughness of 4 Kc/MPa·m⁻² or more, and 0.92% or more of B provides the toughness of more than 4.7 Kc/MPa·m⁻². With 0.92-1.15% by mass of B, magnets having high toughness with suppressed decrease in coercivity and residual magnetic flux density can be stably produced.

The sintered R-TM-B magnet contains 0.07-0.5% by mass of Ga. Ga has a function of increasing not only coercivity but also corrosion resistance. When Ga is 0.07% or less by mass, the coercivity iHc is not improved. On the other hand, the addition of more than 0.5% by mass of Ga would not further improve coercivity and corrosion resistance. Though the addition of 0.07% or more by mass of Ga provides sufficient improvement in corrosion resistance, it is more preferable to add 0.1% or more by mass of Ga. Particularly when Cu is not contained, the amount of Ga contained is preferably 0.2% or more by mass.

The sintered R-TM-B magnet contains 0-0.4% by mass of Cu. Though the effects of the present invention can be obtained by adjusting the amount of Ga without containing Cu, the addition of Cu further improves corrosion resistance. When the Ga content is 0.07% by mass, 0.1% or more by mass of Cu is preferably contained. The addition of more than 0.4% by mass of Cu would not provide further improvement in corrosion resistance.

To obtain sufficient effect of improving corrosion resistance by Ga and Cu in the sintered R-TM-B magnet, the amounts (% by mass) of Ga and Cu are set in a region of a pentagon defined by a point A (0.5, 0.0), a point B (0.5, 0.4), a point C′ (0.1, 0.4), a point D′ (0.1, 0.1) and a point E (0.2, 0.0) on the above X-Y plane. With Ga and Cu in amounts within this region, the sintered R-TM-B magnets having necessary magnetic properties and corrosion resistance can be obtained, with substantially no Ni contained. The term “substantially” is used herein to permit the inclusion of Ni as an inevitable impurity. The weight loss by corrosion drastically increases as the amount of Ga decreases in a region in which the amount of Ga is less than 0.2% by mass. Also, the weight loss by corrosion drastically increases as the amount of Ga decreases in a region in which the amount of Cu is less than 0.1% by mass. Accordingly, attention should be paid fully to composition control. The amounts of Ga and Cu are more preferably in a region of a tetragon defined by a point A (0.5, 0.0), a point B (0.5, 0.4), a point C″ (0.2, 0.4) and a point D″ (0.2, 0.1), most preferably in a region of a tetragon defined by a point A′ (0.5, 0.1), a point B (0.5, 0.4), a point C″ (0.2, 0.4) and a point D″ (0.2, 0.1), on the above X-Y plane.

Though part of Fe may be substituted by Ni, the inclusion of 0.1% or more by mass of Ni undesirably increases breakage drastically particularly in anisotropic cylindrical sintered magnets. Accordingly, the Ni content is preferably less than 0.1% by mass. Though Ni may be contained in the sintered R-TM-B magnet to improve corrosion resistance, the addition of Ni is not indispensable, because the corrosion resistance is improved by Ga or Ga and Cu in the present invention as described above. It is further known that Ni replaces part of Fe, deteriorating the magnetic properties of R-TM-B magnets. However, 0.08% or less by mass of Ni may be contained as an impurity inevitably introduced with Fe. Though the amount of Ni contained as an inevitable impurity is desirably as small as possible, Ni is introduced in a certain percentage, depending on the purity of a starting material used for mass production, or by the addition of a recycled material. The amount of Ni contained as an inevitable impurity is more preferably 0.06% or less by mass.

The sintered R-TM-B magnet may further contain M, wherein M is at least one selected from Zr, Nb, Hf, Ta, W, Mo, Al, Si, V, Cr, Ti, Ag, Mn, Ge, Sn, Bi, Pb and Zn. The addition of small amounts of metal elements M improves coercivity by changing the properties of grain boundary phases, but the addition of large amounts of M reduces a volume ratio of R₂Fe₁₄B phases, resulting in lower Br. Accordingly, M is preferably 3% or less by mass.

(2) Shape of Magnet

The sintered R-TM-B magnet of the present invention is preferably cylindrical. The cylindrical magnet preferably has radial or polar anisotropy. With a cylindrical (ring) shape, it can be assembled as a rotor by reduced number of steps.

A cylindrical magnet having a composition of the sintered R-TM-B magnet of the present invention has good corrosion resistance, and an extremely small amount of Ni, if contained, leads to extremely reduced breakage, chipping, cracking, etc., if any, which are caused by decrease in mechanical strength by the addition of Ni.

In the radially anisotropic R-T-B ring magnet, a ratio D1/D2 of the inner diameter D1 to the outer diameter D2 is preferably 0.7 or more.

When the radially anisotropic R-T-B ring magnet is multi-polar magnetized, the number of magnetic poles may be properly set depending on the specification of motors using the magnet.

In the polar-anisotropic R-T-B ring magnet, a ratio D1/D2 of the inner diameter D1 to the outer diameter D2 is preferably in a range expressed by the formula of D1/D2=1−K(π/P), wherein P represents the number of magnetic poles, and K is 0.51-0.70 at P=4, 0.57-0.86 at P=6, 0.59-0.97 at P=8, 0.59-1.07 at P=10, 0.61-1.18 at P=12, and 0.62-1.29 at P=14.

The polar-anisotropic R-T-B ring magnet may have multi-polar anisotropy having 4, 6, 8, 10, 12 or 14 magnetic poles, with a circular outer peripheral surface and a polygonal inner peripheral surface. In this case, the number of magnetic poles on the outer peripheral surface is preferably an integral multiple of the number of corners of the polygon. At least one middle position between magnetic poles on the outer peripheral surface is preferably aligned with at least one corner of the polygonal inner peripheral surface in a circumferential direction. The number of magnetic poles is preferably the same as or 2 times the number of corners of the polygon. The number of corners of the polygon may be properly set depending on the number of magnetic poles. The polygon is preferably a regular polygon. When the magnet has a polygonal inner peripheral surface, the inner diameter of the magnet is defined as a diameter of a circle circumscribed on the polygon.

(3) Magnetic Properties

The weight loss by corrosion of the sintered R-TM-B magnet of the present invention is preferably less than 2 mg/cm² in a pressure cooker test (120° C., 100% RH, 2 atoms, and 96 hours). The weight loss by corrosion is determined by subtracting the mass after the pressure cooker test under the above conditions from the mass before the test. When the weight loss by corrosion of the sintered R-TM-B magnet is less than 2 mg/cm² in a pressure cooker test under the conditions of 120° C., 100% RH, 2 atoms, and 96 hours, the sintered R-TM-B magnet can meet the corrosion resistance standard required for automobiles (car electronic devices and HVs). To improve corrosion resistance, the weight loss by corrosion should be further reduced. Accordingly, the weight loss by corrosion is more preferably less than 1 mg/cm².

A ring magnet (radially anisotropic, cylindrical magnet or polar-anisotropic, cylindrical magnet) constituted by the sintered R-TM-B magnet of the present invention preferably has mechanical strength of 500 N or more in a radial compression test. The radial mechanical strength of a ring magnet can be measured by a compression test machine shown in FIG. 4. As shown in FIG. 4, measurement using the compression test machine is conducted on a laterally placed ring magnet under a load from above at a speed of 3 mm/sec, to determine a load at a time when the ring magnet is broken, as mechanical strength. The radial mechanical strength is more preferably 800 N or more. When the mechanical strength is less than 500 N, breakage occurs largely during working and handling.

The present invention will be explained in more detail by Experiments below without intention of restriction.

Experiment 1

25 types of alloys having compositions comprising 24.80% by mass of Nd, 6.90% by mass of Pr, 1.15% by mass of Dy, 0.96% by mass of B, 0.15% by mass of Nb, 0.10% by mass of Al, and Ga and Cu in amounts of 0.1, 0.2, 0.3, 0.4 or 0.5% by mass for Ga, and 0.02, 0.1, 0.2, 0.3 or 0.4% by mass for Cu, as shown in Table 1, the balance being Fe and inevitable impurities, were prepared by a strip casting method. These alloys contained 0.06% by mass of Ni as an inevitable impurity. The above Cu content included the amount (0.02% by mass) of Cu introduced as an inevitable impurity.

Each of the resultant alloys was pulverized by a jet mill in a nitrogen gas containing 5000 ppm of oxygen, compression-molded in a magnetic field, sintered, heat-treated, and then ground to obtain a test piece (3 mm×10 mm×40 mm) of a sintered R-TM-B magnet. Each test piece was subjected to a pressure cooker test (120° C., 100% RH, 2 atoms, and 96 hours), to determine weight loss (mg/cm²) by corrosion from the weight change before and after the test. The results are shown in Table 1. The results of each alloy were averaged for three tests (n =3).

TABLE 1

| Weight Loss by | | Cu Content (% by mass) | | | | |
|---|---|---|---|---|---|---|
| Corrosion (mg/cm²) | | 0.02 | 0.1 | 0.2 | 0.3 | 0.4 |
| Ga Content | 0.1 | 6.02 | 1.68 | 0.94 | 0.79 | 0.85 |
| (% by mass) | 0.2 | 1.65 | 0.81 | 0.76 | 0.60 | 0.52 |
| | 0.3 | 1.08 | 0.79 | 0.75 | 0.63 | 0.50 |
| | 0.4 | 0.78 | 0.60 | 0.55 | 0.50 | 0.50 |
| | 0.5 | 0.73 | 0.57 | 0.52 | 0.55 | 0.60 |

The addition of Ga or Ga+Cu reduced the weight loss by corrosion of the sintered R-TM-B magnet, indicating drastic improvement in corrosion resistance. When Cu was not added except for 0.02% by mass of Cu as an inevitable impurity, the weight loss by corrosion was extremely large at the Ga content of 0.1% by mass, but lowered by increasing the Ga content, resulting in good corrosion resistance. When the Ga content was 0.1% by mass, the addition of Cu reduced the weight loss by corrosion, resulting in good corrosion resistance.

The inventors have confirmed that sintered R-TM-B magnets meet the corrosion resistance standard required for automobiles (car electronic devices and HVs), when their weight loss by corrosion by a pressure cooker test at 120° C., 100% RH and 2 atom for 96 hours is less than 2 mg/cm².

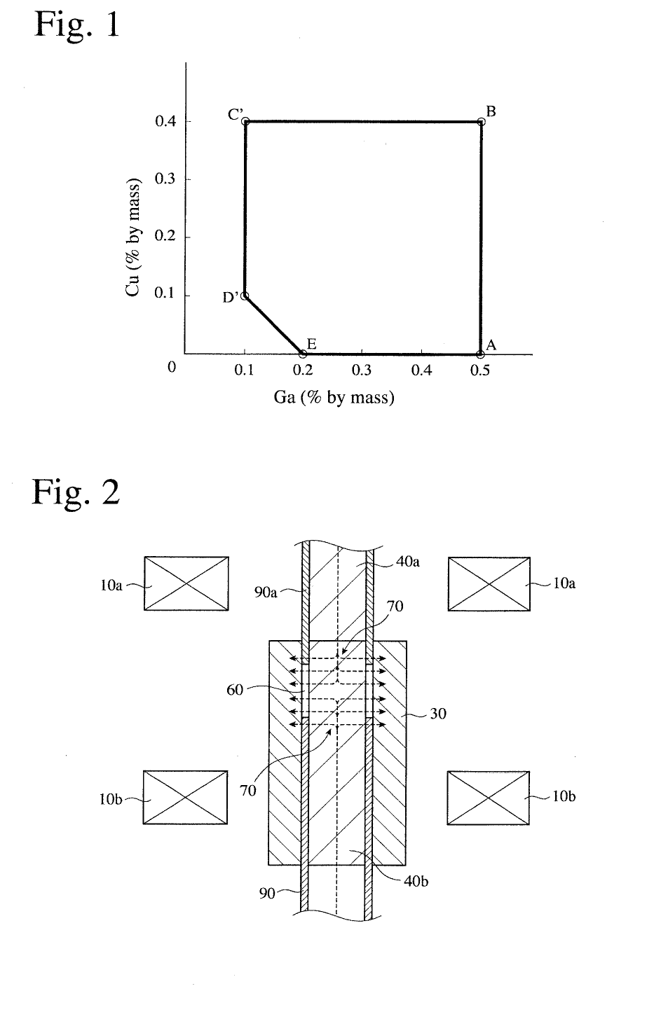

These results reveal that the ranges of the amounts (% by mass) of Cu and Ga meeting weight loss by corrosion of less than 2 mg/cm² with substantially no Ni are in a region of a pentagon defined by the points A, B, C, D and E, on an X-Y plane in which the X-axis represents the amount of Ga, and the Y-axis represents the amount of Cu, as shown in FIG. 1.

Experiment 2

Alloy A comprising 24.80% by mass of Nd, 6.90% by mass of Pr, 1.15% by mass of Dy, 0.96% by mass of B, 0.15% by mass of Nb, 0.10% by mass of Al, 0.30% by mass of Ga, and 0.15% by mass of Cu, the balance being Fe and inevitable impurities, was prepared by a strip casting method. Alloy A contained 0.06% by mass of Ni as an inevitable impurity.

Alloys B to F were prepared in the same manner as Alloy A, except for changing the alloy composition as shown in Table 2. Alloys A to E are in the composition range of the sintered R-TM-B magnet of the present invention, and Alloy F is not in the composition range of the sintered R-TM-B magnet of the present invention.

TABLE 2

| Alloy | Nd | Pr | Dy | B | Nb | Al | Ga | Cu | Ni⁽¹⁾ |
|---|---|---|---|---|---|---|---|---|---|
| A | 24.80 | 6.90 | 1.15 | 0.96 | 0.15 | 0.10 | 0.30 | 0.15 | 0.05 |
| B | 24.20 | 6.80 | 2.00 | 0.95 | 0.15 | 0.06 | 0.08 | 0.10 | 0.03 |
| C | 24.00 | 8.00 | 0.00 | 0.89 | 0.02 | 0.10 | 0.50 | 0.15 | 0.05 |
| D | 21.65 | 6.05 | 4.90 | 0.96 | 0.15 | 0.10 | 0.10 | 0.10 | 0.04 |
| E | 21.65 | 6.05 | 4.90 | 1.06 | 0.15 | 0.30 | 0.10 | 0.10 | 0.08 |
| F | 23.10 | 6.60 | 4.90 | 0.96 | 0.15 | 0.10 | 0.10 | 0.10 | 0.08 |

Note:
⁽¹⁾Ni is an inevitable impurity.

Each of Alloys A to F was pulverized by a jet mill in a nitrogen gas containing 5000 ppm of oxygen, compression-molded in a magnetic field, sintered, heat-treated, and then ground to obtain a test piece (3 mm×10 mm×40 mm) of a sintered R-TM-B magnet. Each test piece was measured with respect to a residual magnetic flux density Bᵣ and coercivity H_{cJ}. The weight loss by corrosion of each test piece was determined from mass change before and after the pressure cooker test (120° C., 100% RH, 2 atoms, and 96 hours). The results are shown in Table 3. The pressure cooker test results of each alloy were averaged for three tests (n=3).

Among the test pieces produced in Experiment 1, Alloy 1 containing 0.1% by mass of Ga and 0.02% by mass of Cu, Alloy 2 containing 0.1% by mass of Ga and 0.4% by mass of Cu, Alloy 3 containing 0.5% by mass of Ga and 0.02% by mass of Cu, and Alloy 4 containing 0.5% by mass of Ga and 0.4% by mass of Cu were measured with respect to a residual magnetic flux density Bᵣ and coercivity H_{cJ}. The results are also shown in Table 3.

TABLE 3

| | weight loss by | | |
|---|---|---|---|
| | corrosion | Br | HcJ |
| Alloy | (mg/cm²) | (T) | (kA/m) |
| A⁽¹⁾ | 0.80 | 1.373 | 1301 |
| B⁽¹⁾ | 1.84 | 1.355 | 1460 |
| C⁽¹⁾ | 0.49 | 1.380 | 1500 |
| D⁽¹⁾ | 0.90 | 1.270 | 1770 |
| E⁽¹⁾ | 0.92 | 1.273 | 1720 |
| F⁽²⁾ | 5.13 | 1.253 | 1793 |
| 1⁽²⁾ | 6.02 | 1.362 | 1301 |
| 2⁽¹⁾ | 0.85 | 1.364 | 1250 |
| 3⁽¹⁾ | 0.73 | 1.362 | 1233 |
| 4⁽¹⁾ | 0.60 | 1.350 | 1342 |

Note:
⁽¹⁾Within the scope of the present invention.
⁽²⁾Comparative Example.

It is clear that Alloys A-E and Alloys 2-4 within the composition range of the sintered R-TM-B magnet of the present invention had small weight loss by corrosion, as well as high residual magnetic flux density Bᵣ and coercivity H_{cJ}. Alloy F had poor corrosion resistance, presumably because the total amount of Nd, Pr and Dy exceeded the amount range of the rare earth element defined in the present invention.

Experiment 4

To evaluate the influence of the Ni content on the mechanical strength of a sintered R-TM-B magnet, the following experiment was conducted.

Nine types of alloys having compositions comprising 24.25% by mass of Nd, 6.75% by mass of Pr, 2.1% by mass of Dy, 0.96% by mass of B, 0.15% by mass of Nb, 0.06% by mass of Al, 0.08% by mass of Ga, and Ni in amounts of 0.0, 0.02, 0.04, 0.06, 0.08, 0.10, 0.20, 0.40 and 0.60% by mass, the balance being Fe and inevitable impurities, were prepared by a strip casting method. Though high-purity metals were used in the experiment, trace amounts of inevitable impurities were contained. Accordingly, an alloy expressed as having the Ni content of “0.0% by mass” may actually contain Ni in a smaller amount than the detectable level (0.01% by mass).

Each of the resultant alloys was pulverized by a jet mill in a nitrogen gas containing 5000 ppm of oxygen to produce fine powder. Each fine powder was compression-molded at 98 MPa in a magnetic field (intensity: 318 kA/m) in the molding apparatus shown in FIG. 2, to obtain a green body (outer diameter: 41.8 mm, inner diameter: 32.5 mm, and height: 47.2 mm) of a radially anisotropic R-TM-B ring magnet. With respect to each alloy, 10 green bodies were produced.

A molding apparatus for forming a radially anisotropic R-TM-B ring magnet comprises a die comprising upper and lower columnar cores 40a, 40b (made of Permendur), an outer cylindrical die 30 (made of SK3), and upper and lower non-magnetic cylindrical punches 90a, 90b; a cavity 60, which is a space surrounded by them; and a pair of magnetic-field-generating coils 10a, 10b disposed around the upper core 40a and the lower core 40b. The upper core 40a is movable away from the lower core 40b; the upper core 40a and the upper punch 90a are independently movable up and down; and the upper punch 90a is movable away from the cavity 60. A radial magnetic field expressed by magnetic force lines 70 is applicable to the cavity 60 through the closed upper and lower cores 40a, 40b.

With a sintering columnar jig (SUS403 having a linear thermal expansion coefficient of 11.4×10⁻⁶, outer diameter: 29.0 mm) inserted into each green body, the green body was placed on a heat-resistant Mo plate in a Mo vessel, and sintered at 1080° C. for 2 hours in vacuum. The sintering jig was coated with a slurry of Nd₂O₃ in an organic solvent on the outer peripheral surface before use. The sintered bodies were ground on the end surfaces and outer and inner peripheral surfaces, to obtain nine radially anisotropic R-TM-B ring magnets 401 to 409 having different Ni contents. It was observed by the naked eye whether the radially anisotropic R-TM-B ring magnets were broken or not. The results are shown in Table 4. The ring magnets 401 to 405 are Reference Examples, in which the Ga contents are outside the present invention, but the Ni contents are less than 0.1% by mass, within the range of the present invention. The ring magnets 406 to 409 are Comparative Examples, in which the Ni contents are 0.1% or more by mass, outside the range of the present invention.

TABLE 4

| Ring | Ni Content | Number of Breakage |
|---|---|---|
| Magnet | (% by mass) | After Cutting |
| 401⁽¹⁾ | 0.00 | 0 |
| 402⁽¹⁾ | 0.02 | 0 |
| 403⁽¹⁾ | 0.04 | 0 |
| 404⁽¹⁾ | 0.06 | 0 |
| 405⁽¹⁾ | 0.08 | 0 |
| 406⁽²⁾ | 0.10 | 3 |
| 407⁽²⁾ | 0.20 | 5 |
| 408⁽²⁾ | 0.40 | 10 |
| 409⁽²⁾ | 0.60 | 10 |

Note:
⁽¹⁾Reference Example.
⁽²⁾Comparative Example.

The results shown in Table 4 indicate that breakage occurred in the sintered ring magnets when the Ni content was 0.1% or more by mass, and that more breakage occurred as the Ni content increased.

### Experiment 5

Radially anisotropic R-TM-B ring magnets were produced in the same manner as in Experiment 4, except for changing the Ni content as shown in Table 5, and their size to 44.0 mm in outer diameter, 38.0 mm in inner diameter, and 34.0 mm in height.

With respect to each radially anisotropic ring magnet, the mechanical strengths of 10 samples were measured by the compression test machine shown in FIG. 4, and averaged. As shown in FIG. 4, measurement using the compression test machine was conducted on a laterally placed ring magnet under a load from above at a speed of 3 mm/sec, to determine a load at a time when the ring magnet was broken, as mechanical strength. The results are shown in Table 5.

TABLE 5

| Ring | Ni Content | Mechanical |
|---|---|---|
| Magnet | (% by mass) | Strength (N) |
| 501⁽¹⁾ | 0.025 | 1600 |
| 502⁽¹⁾ | 0.055 | 1000 |
| 503⁽¹⁾ | 0.062 | 1000 |
| 504⁽¹⁾ | 0.065 | 900 |
| 505⁽¹⁾ | 0.075 | 800 |
| 506⁽¹⁾ | 0.083 | 700 |
| 507⁽¹⁾ | 0.091 | 500 |
| 508⁽²⁾ | 0.100 | 300 |

Note:
⁽¹⁾Reference Example.
⁽²⁾Comparative Example.

It was continued by the results shown in Table 5 that as the Ni content increased, the mechanical strength decreased. The inventors' investigation confirms that when the mechanical strength is less than 500 N, breakage occurs largely in working and handling.

Experiment 6

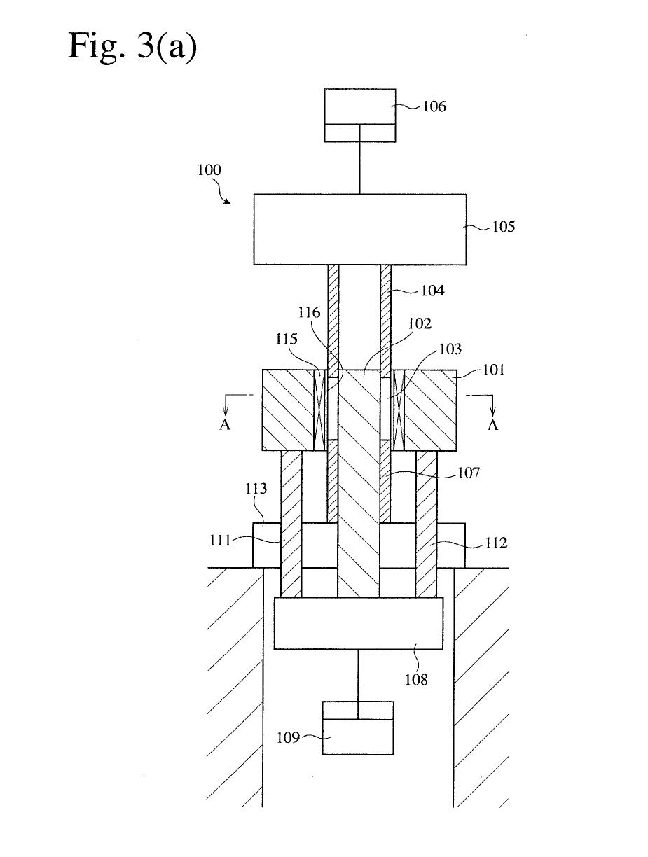

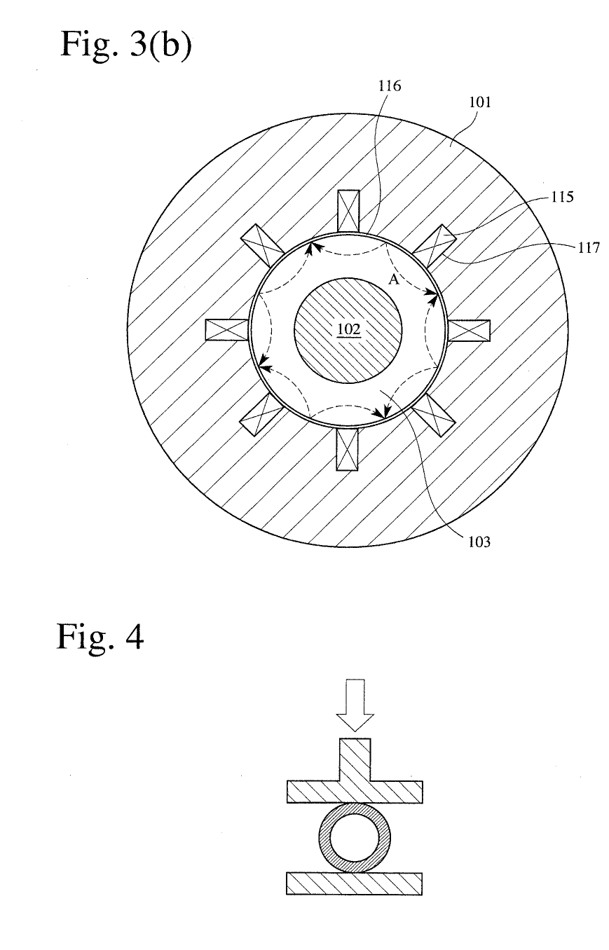

Using the molding apparatus 100 shown in FIG. 3, each of nine fine alloy powders prepared as in Experiment 4 was compression-molded at pressure of 80 MPa, in a pulse magnetic field having the same intensity for all alloy powders, to obtain a green body (31.5 mm in outer diameter, 20.3 mm in inner diameter, and 27.8 mm in height) for a polar-anisotropic R-TM-B ring magnet having 8 magnetic poles on the outer peripheral surface. With respect to each alloy, 10 green bodies were produced.

The molding apparatus 100 for forming the polar-anisotropic R-TM-B ring magnet in a magnetic field comprises, as shown in FIG. 3(a), a magnetic die 101, and a non-magnetic columnar core 102 concentrically disposed in an annular space of the die 101, the die 101 being supported by supports 111, 112, and both of the core 102 and the supports 111, 112 being supported by a lower frame 108. An upper, cylindrical, non-magnetic punch 104, and a lower, cylindrical, non-magnetic punch 107 are inserted into a molding space 103 between the die 101 and the core 102. The lower punch 107 is fixed to a base 113, and the upper punch 104 is fixed to an upper frame 105. The upper frame 105 and the lower frame 108 are connected to an upper cylinder 106 and a lower cylinder 109, respectively.

FIG. 3(b) shows a cross section taken along the line A-A in FIG. 3(a). Pluralities of grooves 117 are formed on an inner surface of the cylindrical die 101, and a magnetic-field-generating coil 115 is placed in each groove 117. The die 101 is provided with an annular non-magnetic sleeve 116 covering the grooves on the inner surface. The molding space 103 is defined by the annular sleeve 116 and the core 102. In FIG. 3(b), current flows in the magnetic-field-generating coil 115 in each groove 117 in a perpendicular direction to the paper surface, and circumferentially adjacent coils are connected to flow current alternately in opposite directions. With current flowing in the magnetic-field-generating coils 115, a magnetic flux shown by the arrows A is generated in the molding space 103, so that magnetic poles (8 poles in the figure) having circumferentially alternating polarities of S, N, S, N . . . are formed at points (start and end points of each arrow) of the annular sleeve, through which magnetic fluxes pass.

The resultant green body was placed on a heat-resistant Mo plate in a Mo vessel, and sintered at 1080° C. for 2 hours in vacuum. The end surfaces and outer and inner peripheral surfaces of the sintered bodies were ground to produce nine polar-anisotropic R-TM-B ring magnets 601 to 609 having different Ni contents. It was observed by the naked eye whether the polar-anisotropic R-TM-B ring magnets were broken or not. The results are shown in Table 6. The ring magnets 601 to 605 are Reference Examples, in which their Ga contents are outside the present invention, but their Ni contents are less than 0.1% by mass, within the range of the present invention. The ring magnets 606 to 609 are Comparative Examples, in which their Ni contents are 0.1% or more by mass, outside the range of the present invention.

TABLE 6

| Ring | Ni Content | Number of Breakage |
|---|---|---|
| Magnet | (% by mass) | After Cutting |
| 601⁽¹⁾ | 0.0 | 0 |
| 602⁽¹⁾ | 0.02 | 0 |
| 603⁽¹⁾ | 0.04 | 0 |
| 604⁽¹⁾ | 0.06 | 0 |
| 605⁽¹⁾ | 0.08 | 0 |
| 606⁽²⁾ | 0.10 | 5 |
| 607⁽²⁾ | 0.20 | 8 |
| 608⁽²⁾ | 0.40 | 10 |
| 609⁽²⁾ | 0.60 | 10 |

Note:
⁽¹⁾Reference Example.
⁽²⁾Comparative Example.

The results shown in Table 6 indicate that breakage occurred in the sintered ring magnets when the Ni content was 0.1% or more by mass, and that more breakage occurred as the Ni content increased.

Experiment 7

The radially anisotropic sintered ring magnets of the present invention were produced in the same manner as in Experiment 4, except for using 25 types of fine alloy powders prepared in the same manner as in Experiment 1. No breakage occurred after grinding in any of 25 types of these radially anisotropic sintered ring magnets.

Experiment 8

The polar-anisotropic sintered ring magnets of the present invention were produced in the same manner as in Experiment 6, except for using 25 types of fine alloy powders produced in the same manner as in Experiment 1. No breakage occurred after grinding in any of 25 types of these radially anisotropic sintered ring magnets.

Experiment 9

Five types of alloys having compositions comprising 24.80% by mass of Nd, 6.90% by mass of Pr, 1.15% by mass of Dy, 0.15% by mass of Nb, 0.10% by mass of Al, 0.3% by mass of Ga, 0.2% by mass of Cu, and B in amounts of 0.88, 0.89, 0.92, 0.95, and 1.15% by mass, the balance being Fe and inevitable impurities, were prepared by a strip casting method. These alloys contained 0.06% by mass of Ni as an inevitable impurity, with no Co. The above Cu content included the amount (0.02% by mass) of Cu introduced as an inevitable impurity.

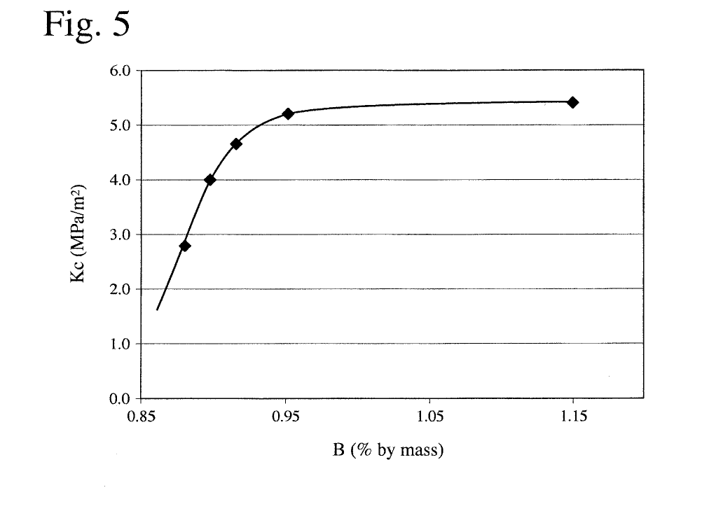

Each of the alloys was pulverized by a jet mill in a nitrogen gas containing 5000 ppm of oxygen, compression-molded in a magnetic field, sintered, heat-treated, and ground to obtain a test piece (3 mm×10 mm×40 mm) of the sintered R-TM-B magnet. An indenter of a Vickers hardness tester was pressed onto a mirror-polished surface of each test piece under a load of 10 kgf to form a dent. The fracture toughness of each test piece was measured by an indenter fracture (IF) method according to JIS R1607. The measurement results are shown in FIG. 5.

The fracture toughness was as high as 4.0 Kc/MPa·m⁻² at the B content of 0.89% by mass, and 4.7 Kc/MPa·m⁻² at the B content of 0.92% by mass. Chipping during handling was low at the B content of 0.89% by mass, and lower at the B content of 0.92% by mass. With the B content of 0.85% by mass, chipping can be reduced in sufficiently careful handling. At the B content of 0.95% or more by mass, the fracture toughness was in an equilibrium state. Taking into consideration the magnetic properties which decrease when B exceeds 1.15% by mass, and possible composition unevenness in mass production, the upper limit of the B content is desirably 1.10% by mass.

### EFFECTS OF THE INVENTION

With Ga and Cu added in proper ranges in place of Ni to improve corrosion resistance, the sintered R-TM-B magnets of the present invention exhibit high mechanical strength and excellent corrosion resistance, so that the sintered R-TM-B magnets suffer less breakage, chipping, cracking, etc. Accordingly, they can be formed into anisotropic, cylindrical, sintered R-TM-B magnets (radially anisotropic, cylindrical magnets and polar-anisotropic, cylindrical magnets) likely having residual stress. The sintered R-TM-B magnets of the present invention are suitably used for rotors.

What is claimed is:

1. A sintered R-TM-B magnet comprising 24.5-34.5% by mass of R, wherein R is at least one selected from rare earth elements including Y, 0.92-1.15% by mass of B, less than 0.1% by mass of Ni, 0.07-0.5% by mass of Ga, 0-0.4% by mass of Cu, and inevitable impurities, the balance being Fe;
the amounts (% by mass) of Ga and Cu being in a region of a pentagon defined by a point A (0.5, 0.0), a point B (0.5, 0.4), a point C′ (0.1, 0.4), a point D′ (0.1, 0.1) and a point E (0.2, 0.0), on an X-Y plane in which the X-axis represents the amount of Ga, and the Y-axis represents the amount of Cu.

2. The sintered R-TM-B magnet according to claim 1, which further comprises 3% or less by mass of M, wherein M is at least one selected from the group consisting of Zr, Nb, Hf, Ta, W, Mo, Al, Si, V, Cr, Ti, Ag, Mn, Ge, Sn, Bi, Pb and Zn.

3. The sintered R-TM-B magnet according to claim 1, wherein the amount of B is 0.92-1.10% by mass.

4. The sintered R-TM-B magnet according to claim 1, wherein the amounts (% by mass) of Ga and Cu are in a region of a tetragon defined by a point A′ (0.5, 0.1), a point B (0.5, 0.4), a point C″ (0.2, 0.4) and a point D″ (0.2, 0.1), on an X-Y plane in which the X-axis represents the amount of Ga, and the Y-axis represents the amount of Cu.

5. The sintered R-TM-B magnet according to claim 1, wherein the weight difference (weight loss by corrosion) before and after a pressure cooker test (120° C., 100% RH, 2 atoms, and 96 hours) is less than 2 mg/cm².

6. The sintered R-TM-B magnet according to claim 1, which is a radially anisotropic, cylindrical magnet or a polar-anisotropic, cylindrical magnet.
